(19) United States
(12) Patent Application Publication
(10) Pub. No.: US 2018/0056943 A1
(43) Pub. Date: Mar. 1, 2018

(54) WINDSCREEN WIPER DRIVE DEVICE AND WIPING SYSTEM

(71) Applicant: Valeo Systèmes d'Essuyage, Le Mesnil Saint Denis (FR)

(72) Inventor: Cyrille Girodot, Issoire (FR)

(73) Assignee: Valeo Systèmes d'Essuyage, Le Mesnil Saint Denis (FR)

(21) Appl. No.: 15/684,213

(22) Filed: Aug. 23, 2017

(30) Foreign Application Priority Data
Aug. 24, 2016 (FR) 1657894

(51) Int. Cl. B60S 1/08; B60S 1/16

(52) U.S. Cl. CPC B60S 1/0803; B60S 1/163

(57) ABSTRACT

The invention relates to a drive device 3 comprising an electric motor 10 for driving a windscreen wiper 2 of a motor vehicle in a reciprocating movement and a device for identifying a rest position 4 of said motor 10, said rest position being a position in which the rotation of said motor 10 is stopped in order to stop a reciprocating cycle of the windscreen wiper 2 at the start or end of the upstroke or at the start or end of the downstroke of the windscreen wiper 2, characterized in that said device for identifying a rest position 4 comprises a first and a second angular reference point 20a, 20b, in that said motor 10 is configured for driving said first and second angular reference points 20a, 20b in rotation, the first and second angular reference points 20a, 20b being arranged on a circle C and diametrically opposed, and in that said drive device 3 is configured so that one of the first and second angular reference points 20a, 20b may be chosen to correspond to the rest position 4 of said motor 10.

The invention also relates to a wiping system 1 comprising two drive devices 3.

The invention relates to a drive device comprising an electric motor for driving a windscreen wiper of a motor vehicle in a reciprocating movement, and to a device for identifying a rest position of said motor. The invention also relates to a wiping system for windscreen wipers of motor vehicles.

Geared motor units for motor vehicle windscreen wipers are provided with a reference point which identifies a rest position of the motor at a predetermined angular position after the user has commanded the wiping to stop. Thus the motor can be made to stop in a repeatable predetermined angular position, for example in order to stop the windscreen wiper in the horizontal position, at the bottom of the glazed surface.

In some motor vehicles, one or two glazed surfaces are swept by means of two windscreen wipers which sweep in a symmetrical manner. This is the case, notably, for the sweeping of glazed surfaces of the hinged right and left rear doors of some vehicles equipped with two rear doors.

In these vehicles, the rest positions of the right and left windscreen wipers are symmetrically inverted. This results in a different positioning of the reference point of the rest position of the motor. The right and left geared motor units must therefore be differentiated, to prevent any error in the assembly of the motor vehicle. Various means may be used for this purpose.

One of these means is the inversion of the positioning of the fastening means in order to distinguish the enclosures in which the geared motor units are mounted, in such a way that the geared motor unit for mounting on the right door cannot be mounted on the left door, and vice versa.

This results in relatively high manufacturing costs, since two different sets of equipment must be provided for the manufacture of the geared motor units with reference points for identifying two symmetrical rest positions. Equally, two different sets of equipment must be provided for moulding enclosures having symmetrically inverted fastening means. Moreover, the management of procurement for the geared motor units is relatively constraining, since two separate procurement flows must be provided for these two different reference points.

One object of the present invention is to overcome the above drawbacks.

For this purpose, the present invention proposes a drive device comprising an electric motor for driving a windscreen wiper of a motor vehicle in a reciprocating movement and a device for identifying a rest position of said motor, said rest position being a position in which the rotation of said motor is stopped in order to stop a reciprocating cycle of the windscreen wiper at the start or end of the upstroke or at the start or end of the downstroke of the windscreen wiper, wherein said device for identifying a rest position comprises a first and a second angular reference point, wherein said motor is configured for driving said first and second angular reference points in rotation, the first and second angular reference points being arranged on a circle C and diametrically opposed, and wherein said drive device is configured so that one of the first and second angular reference points may be chosen to correspond to the rest position of said motor.

The first and second angular reference points are therefore remote from one another. The angular reference points, positioned symmetrically to correspond to the two end positions of the windscreen wipers, enable the same device for detecting a rest position to be used for the right and left doors. A rest position is determined, by means of a program in a processing unit of the motor vehicle, as corresponding to the first or second angular reference point.

According to an exemplary embodiment, the first and the second angular reference points are distinct from one another, having different angles at the centre of the circle C. Thus the upstrokes and downstrokes of the sweep cycle of a device for identifying a rest position may be discriminated, and the intermediate reference point as described below may then advantageously be omitted.

According to another exemplary embodiment, the first and the second angular reference points are distinct from one another, having different forms of magnetization. This also makes it possible to discriminate the upstrokes and downstrokes of the sweep cycle of a device for identifying a rest position. Here again, the intermediate reference point as described below may advantageously be omitted.

This avoids the use of different sets of equipment which are required in the prior art for the manufacture of geared motor units whose reference points must be positioned in symmetrical rest positions, and also avoids the use of different sets of equipment for moulding distinct types of enclosures. The manufacturing and assembly costs are therefore reduced. The management of procurement is also facilitated, since the right and left drive devices are identical.

According to an exemplary embodiment, the device for identifying a rest position further comprises at least one intermediate angular reference point which is arranged on the circle C in which the first and second reference points are inscribed, and which is spaced apart from the first and second angular reference points. Additionally, the number of intermediate angular reference points arranged on one semicircle between the first and the second angular reference points is greater than the number of intermediate angular reference points arranged on the other semicircle.

By using at least one intermediate angular reference point, rather than the distinct first and second angular reference points only, it is possible to avoid any errors of interpretation of the detection signal that may occur as a result of possible differences in the rotation speed of the motor, which might falsify the measured duration of contact with the distinct first and second angular reference points.

Furthermore, the refresh time of the processing unit may be such that the “boundaries” of the distinct angular reference points cannot be detected in a sufficiently precise way, so that the information on the angle at the centre of the circle C does not prevent an unwanted sweep cycle.

However, the intermediate angular reference point makes it possible to discriminate the upstrokes and downstrokes with greater precision, since the counting of the peaks is independent of the refresh time of the processing unit and the rotation speed of the motor. Thus it can be ensured that no unwanted sweep cycle will take place, making it possible, notably, to provide sweeping with a single sweep cycle, or what is known as an “intermittent” sweep, in which the windscreen wipers remain in the rest position for a predetermined duration between each sweep cycle.

It is also possible to stop the rotation of the motor as soon as the processing unit detects an expected rising edge as that of the peak corresponding to the predetermined angular position of a rest position. By providing detection on the rising edge, it may be unnecessary to measure the angle at the centre of the circle C of the switched angular reference point before it is possible to determine whether it corresponds to one or the other of the end positions.

According to one or more characteristics of the device for identifying a rest position, considered individually or in combination,
the device for identifying a rest position comprises a single intermediate angular reference point,
the angles of the angular reference points at the centre of the circle C are identical,
the angle of the intermediate angular reference point at the centre of the circle C is different from the angles at the centre of the circle C of the first and second angular reference points,
the first and the second angular reference points have different angles at the centre of the circle C,
the angular reference points are made of metal,
the device for identifying a rest position comprises a reference point follower, elastically biased against the circle C in which the angular reference points are inscribed,
the device for identifying a rest position comprises:
   a continuous annular track, coaxial with the circle C in which the angular reference points are inscribed, and connected to the angular reference points, and
   a track follower, elastically biased against the continuous annular track,
the continuous annular track and the track follower are made of metal,
the angular reference points are carried by a rotary element which is driven in rotation by the electric motor of the windscreen wiper, the angular reference points being inscribed on a circle C coaxial with the rotary element,
the rotary element is a gear wheel driven in rotation by the electric motor of the windscreen wiper,
the rotary element is made of plastic material,
the device for identifying a rest position comprises electrical or optical or magnetic means for detecting the angular reference points.

The invention also proposes a wiping system comprising two drive devices according to any of the definitions above, for driving respective windscreen wipers, said system being such that a first and a second windscreen wiper are configured to sweep symmetrically at least one glazed surface of a motor vehicle.

According to one or more characteristics of the wiping system, considered individually or in combination,
the devices for identifying a rest position of the drive devices are identical,
the rest positions of the motors are symmetrically inverted,
the processing unit is adapted to set said rest position of each of the motors, respectively, to the first or the second angular reference point,
the rest positions of the motors are symmetrically inverted, Thus, it is possible to devise a wiping system in which the devices for identifying a rest position of the drive devices are identical, and in which a first motor has a rest position set to the first angular reference point, and a second motor has a rest position set to the second angular reference point, so that the rest position of each of the motors is symmetrically inverted.

Other advantages and characteristics will be apparent from a perusal of the description of a non-limiting exemplary embodiment of the invention, and from the attached drawings, in which:

FIG. 1 shows in a schematic manner a wiping system for rear doors of a motor vehicle,

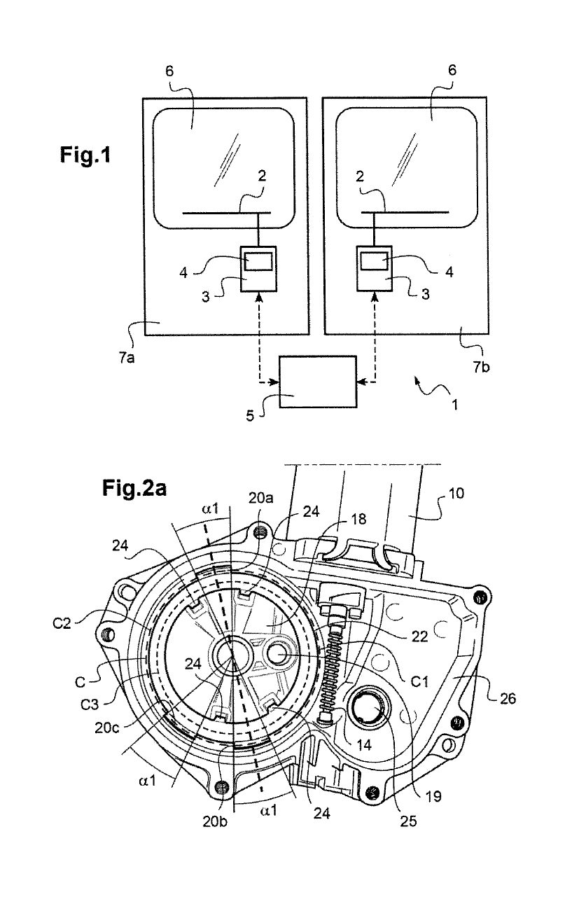

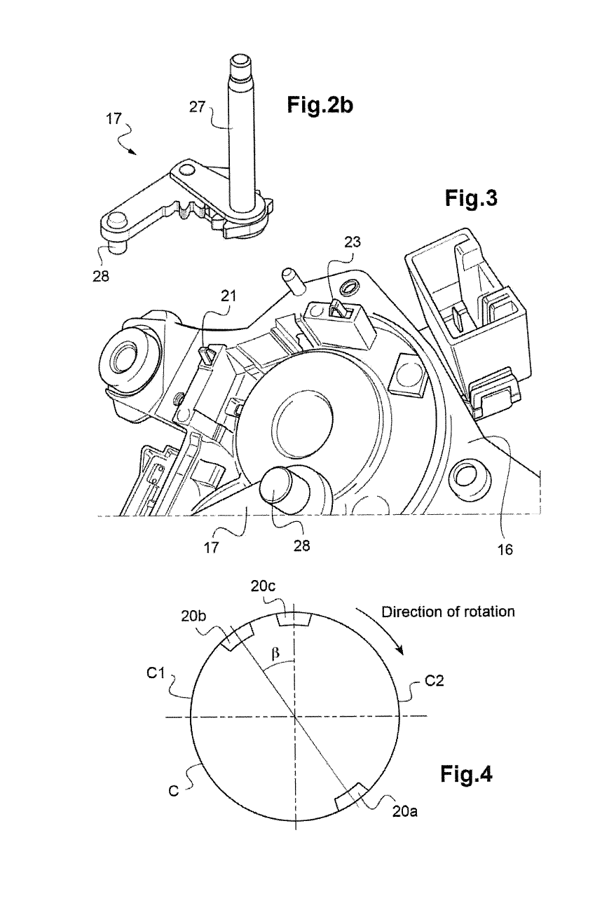

FIG. 2a shows elements of a first part of a drive device,

FIG. 2b shows a linkage member of the first part of the drive device of FIG. 2a,

FIG. 3 shows elements of a second part of the drive device, assembled on to the first part shown in FIG. 2a,

FIG. 4 shows a schematic representation of a first example of a device for identifying a rest position,

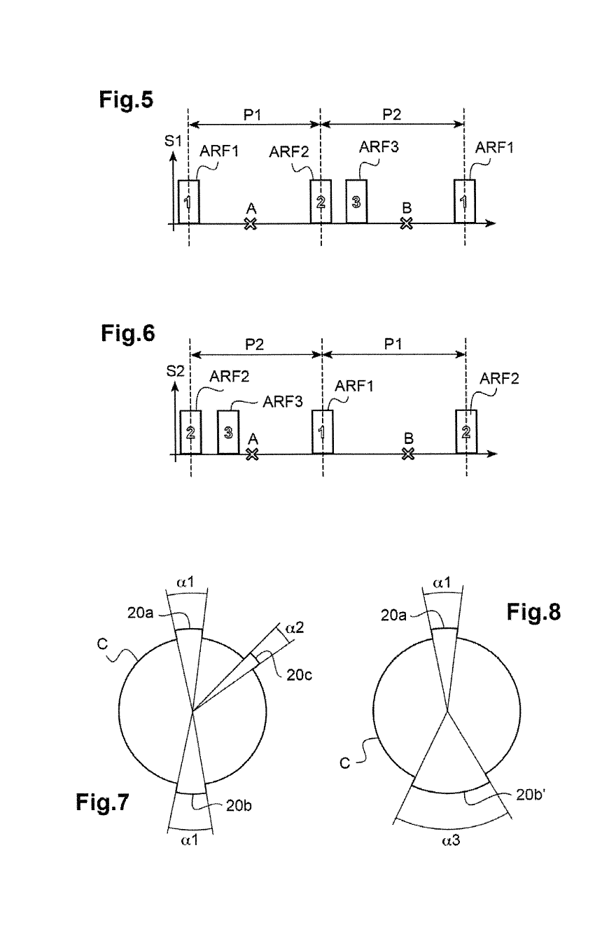

FIG. 5 shows an example of a detection signal as a function of time, found for a device for identifying a rest position of the left door wiping system,

FIG. 6 shows an example of a detection signal as a function of time, found for a device for identifying a rest position of the right door wiping system,

FIG. 7 shows a schematic representation of a second example of a device for identifying a rest position, and

FIG. 8 shows a schematic representation of a third example of a device for identifying a rest position.

In these drawings, identical or similar elements are given the same reference numerals.

The following embodiments are examples. Although the description refers to one or more embodiments, this does not necessarily mean that each reference concerns the same embodiment, or that the characteristics are applicable to a single embodiment only. Characteristics of different embodiments may also be combined to create other embodiments.

With reference to FIG. 1, a wiping system 1 for a motor vehicle windscreen wiper 2 is shown.

The wiping system 1 comprises two drive devices 3 for driving respective windscreen wipers 2.

Each drive device 3 comprises an electric motor 10 for driving a respective windscreen wiper 2 and a device for identifying a rest position 4 of the motor 10.

The windscreen wipers 2 are intended to sweep at least one glazed surface 6 of a motor vehicle in a symmetrical manner (also referred to as an “opposed” or “butterfly” arrangement), each sweep cycle comprising an upstroke (or “forward” stroke) of the windscreen wiper 2 on the glazed surface 6, followed by a downstroke (or “return” stroke), at the end of which the blade of the windscreen wiper 2 returns to its initial position. The windscreen wipers 2 are, for example, intended to sweep two glazed surfaces 6 of hinged rear doors 7a, 7b of a motor vehicle.

The devices for detecting a rest position 4 are connected to a processing unit 5 of the vehicle. The processing unit 5 is a central programmable electronics unit of the vehicle, such as a computer, which also controls the operation of other components of the vehicle, such as the opening of the doors, the direction indicators, or the like.

The devices for detecting a rest position 4 enable the processing unit 5 to command the motors 10 to stop in a predetermined angular position called the “rest position” (or “fixed stop” or “parking position”), (or “park position” in English), after the user has commanded the motor 10 to stop, for example in order to stop the windscreen wipers 2 substantially in the horizontal or substantially in the vertical position, in one of the two end positions of the windscreen wiper 2, that is to say at the start or end of the upstroke or at the start or end of the downstroke.

More clearly visible in an exemplary embodiment shown in FIGS. 2a, 2b and 3, the motor 10, of the d.c. type, drives a shaft projecting from the rotor, which carries an endless screw 14. The drive device 3 also comprises a gear wheel 18 which engages with the endless screw 14, and a linkage member 17 (FIG. 2b).

The linkage member 17 is a connecting rod and crank system having an input shaft 28 and an output shaft 27 which are both articulated. The input shaft 28 is mounted in a cavity 19 in an eccentric position on the gear wheel 18, and a first end of the output shaft 27 is mounted in a cavity 25 of the casing 26 of the drive device 3.

The second end of the output shaft 27 is intended to be assembled with an element of the windscreen wiper 2 to be driven in a pivoting manner, such as an end of a windscreen wiper arm (not shown).

As may be seen in the illustrative example of FIG. 2a, the device for identifying a rest position 4 comprises a first and a second angular reference point 20a, 20b.

The first and second angular reference points 20a, 20b are carried by a rotary element of the drive device 3 which is driven in rotation by the electric motor 10 of the windscreen wiper 2 in operation. They are, for example, carried by the gear wheel 18.

The first and second angular reference points 20a, 20b are inscribed on a circle C coaxial with the rotary element, and are diametrically opposed. The angular reference points 20a and 20b are also positioned so as to correspond to the end positions of the windscreen wipers 2 in a sweep cycle. Thus, the rotation of the rotary element through 360° corresponding to a sweep cycle comprises an upstroke on a semicircle C1 (or C2) located between the first and second angular reference points 20a and 20b and a downstroke on the other semicircle.

The first and second angular reference points 20a, 20b have, for example, the shape of at least a part of an angular sector, such as the shape of an arc of a circle. Provision is made, for example, for them to cover an angle α1 at the centre of the circle C in the range from 10° to 30°.

According to an exemplary embodiment, the first and the second angular reference points are distinct from one another, having different forms of magnetization. This makes it possible to discriminate the upstrokes and downstrokes of the sweep cycle of a device for identifying a rest position.

According to another embodiment, the device for identifying a rest position 4 comprises at least one intermediate angular reference point 20c.

The at least one intermediate angular reference point 20c is arranged on the circle C on which the first and second reference points are inscribed. It may be arranged anywhere on the circle C, but it is spaced apart from the first and second angular reference points 20a, 20b; that is to say, it does not overlap the first and/or the second angular reference point 20a, 20b. For example, the second angular reference point 20b and the intermediate angular reference point 20c are spaced apart by an angle β at the centre of the circle C, as measured between the respective centres of the second angular reference point 20b and the intermediate angular reference point, of 40° (FIG. 4).

Like the first and second angular reference points 20a, 20b, the at least one intermediate angular reference point 20c is carried by the rotary element driven in rotation by the motor 10, such as the gear wheel 18, and is inscribed on the circle C coaxial with the rotary element. The intermediate angular reference point 20c has, for example, the shape of at least a part of an angular sector, such as the shape of an arc of a circle, covering for example an angle α1 at the centre of the circle C in the range from 10° to 30°.

Additionally, the number of intermediate angular reference points 20c arranged on a first semicircle C1 between the first and the second angular reference points 20a, 20b is greater than the number of intermediate angular reference points 20c arranged on the second semicircle C2 between the first and the second angular reference points 20a, 20b.

In the example shown in FIG. 2a, the device for identifying a rest position 4 comprises a single intermediate angular reference point 20c, arranged on the second semicircle C2, and no intermediate angular reference point on the other semicircle C1.

According to an exemplary embodiment shown in FIGS. 2a and 4, the angles α1 of the first and second angular reference points 20a, 20b and of the intermediate angular reference point 20c at the centre of the circle C are identical.

According to an exemplary embodiment, the angular reference points 20a, 20b, 20c are detected by electrical switching, using means for electrically detecting the angular reference points 20a, 20b, 20c.

For this purpose, the device for identifying a rest position 4 comprises a reference point follower 21, mounted elastically in an enclosing element 16 of the drive device 3 (FIG. 3).

The reference point follower 21 is elastically biased against the rotary element, on the circle C in which the angular reference points 20a, 20b, 20c are inscribed.

Provision may also be made, for example, for the rotary element to be made of an insulating material, for example a plastic such as polyoxymethylene (abbreviated to POM).

Provision is also made for the angular reference points 20a, 20b, 20c to be conductive elements. They are, for example, formed by metal tracks, cut out for example, such as brass or copper tracks.

According to another example, provision is made for the rotary element to be conductive and for the angular reference points to be made of an insulating material.

The device for identifying a rest position 4 also comprises a continuous annular track 22 (FIG. 2a) and a track follower 23 (FIG. 3), elastically biased against the continuous annular track 22.

The continuous annular track 22 may be carried by the rotary element. It is coaxial with the rotary element and with the angular reference points 20a, 20b, 20c. The continuous annular track 22 is also conductive and is electrically connected to the conductive angular reference points 20a, 20b, 20c.

The continuous annular track 22 is, for example, made of metal, and may be made in one piece with the conductive angular reference points 20a, 20b, 20c, which are formed by cutting out, for example. The continuous annular track 22 and the angular reference points 20a, 20b, 20c are thus arranged on the same plane.

According to an exemplary embodiment shown in FIG. 2a, the continuous annular track 22 is located on a circle C3, inside and coaxial with the circle C in which the angular reference points 20a, 20b, 20c are inscribed.

The metal plate comprising the continuous annular track 22 and the angular reference points 20a, 20b, 20c may be held on the rotary element by means of at least two bent lugs 24 of the metal plate which are inserted into complementary recesses in the rotary element (four bent lugs 24 are shown by way of example in FIG. 2a).

The sector follower 21 and the track follower 23 are also conductive.

According to an exemplary embodiment, the sector follower 21 and the track follower 23 are formed by metal blades bent back on themselves (in a V-shape) so as to project towards the rotary element, that is to say towards the angular reference points 20a, 20b, 20c and the continuous annular track 22, respectively. The bent metal blades provide the necessary elasticity to bias the followers 21, 23 elastically against the circle C and against the continuous annular track 22, respectively.

The sector and track followers may also be made in different ways. For example, the sector follower comprises a pin and an elastic member, such as a spring, biasing the pin towards the rotary element (not shown).

Provision may also be made to provide an annular groove in the rotary element on the circle C in which the angular reference points 20a, 20b, 20c are inscribed, to facilitate the travel of the reference point follower 21 along the circle C.

The sector follower 21 and the track follower 23 are also connected to the processing unit 5 of the vehicle, which, in operation, supplies power to one of the two followers 21, 23 and receives a detection signal on the other follower 21, 23, the detection signal comprising a peak when the reference point follower 21 contacts an angular reference point 20a, 20b, 20c.

Thus, when the wiping system 1 is in operation, the rotation of the rotary element (the gear wheel 18 in the present case) through 360° causes successive contacts between the angular reference points 20a, 20b, 20c and the reference point follower 21, as well as a continuous contact between the track follower 23 and the continuous annular track 22.

The contact between the reference point follower 21 and an angular reference point 20a, 20b, 20c, on the one hand, and between the track follower 23 and the continuous annular track 22, on the other hand, allows an electric current to flow between the two followers 21, 23, generating a peak in the detection signal received by the processing unit 5 of the vehicle.

Thus, FIG. 5 shows the detection signal S1 obtained over a sweep cycle for a first device for identifying a rest position 4 of the wiping system 1, for example that of the windscreen wiper 2 for wiping the glazed surface 6 of the left rear door 7a (seen from the rear of the vehicle), the device for detecting a rest position 4 shown in FIG. 4 rotating in the clockwise direction.

The processing unit 5 is configured to set a rest position of the motor 10 at the first or second angular reference point 20a, 20b, for example at the first angular reference point 20a.

When the reference point follower 21 travels through the first semicircle C1, corresponding to the upstroke of the sweep cycle for example, the detection signal S1 received by the processing unit 5 comprises, in a first portion P1, a first peak ARF1 corresponding to the contact with the first angular reference point 20a (the first end position of the windscreen wiper 2), and a second peak ARF2 corresponding to the contact with the second angular reference point 20b (the second end position of the windscreen wiper 2). Between the first angular reference point 20a and the second angular reference point 20b, the reference point follower 21 contacts the non-conductive material of the rotary element, and the electrical signal received by the processing unit 5 is therefore zero.

Then, when the reference point follower 21 sweeps the second semicircle C2, corresponding to the downstroke of the sweep cycle in this example, the detection signal S1 comprises, in a second portion P2, in addition to the first and second peaks ARF1, ARF2, a third peak ARF3 corresponding to the contact with the intermediate angular reference point 20c.

Since the first and second angular reference points 20a, 20b are diametrically opposed and positioned so as to correspond to the end positions of the windscreen wipers 2 in the upstroke and downstroke, the detection signal S1 has an identical gap between the first and second peaks ARF1, ARF2, enabling the sequence of phases of the sweep cycle to be identified.

The resulting detection signal S1 is also asymmetrical, the first portion P1 of the detection signal S1 being different from the second portion P2 which comprises a third peak ARF3. The processing unit 5 can thus determine, when the user requests that the wiping be stopped (case A or B), whether the windscreen wiper 2 is in the upstroke or the downstroke, by counting the number of third peaks ARF3 located between the regularly spaced first and second peaks ARF1, ARF2.

The processing unit 5 can then determine whether it must command the motor 10 to stop on the detection of the rising edge of the next peak ARG1 which it expects to correspond to the next detected angular reference frame (case B in FIG. 5), since it has determined that it is in the downstroke of the sweep cycle (portion P2), or whether it must wait for the passage of three successive angular reference points 20b, 20c, 20a before the motor 10 reaches the angular position determined for the fixed stop (case A in FIG. 5).

With at least one intermediate angular reference point 20c, rather than the distinct first and second angular reference points 20a, 20b′ only, it is possible to avoid any errors of interpretation of the detection signal S1 that may occur as a result of possible differences in the rotation speed of the motor 10, which might falsify the measured duration of contact with the distinct first and second angular reference points 20a, 20b′.

Additionally, the refresh time of the processing unit 5 may be such that the “boundaries” of the distinct angular reference points 20a, 20b′ cannot be detected in a sufficiently precise way, so that the information on the angle at the centre of the circle C does not prevent an unwanted sweep cycle.

However, the intermediate angular reference point 20c makes it possible to discriminate the upstrokes and downstrokes with greater precision, since the counting of the peaks is independent of the refresh time of the processing unit 5 and of the rotation speed of the motor 10. Thus it can be ensured that no unwanted sweep cycle will take place, making it possible, notably, to provide sweeping with a single sweep cycle, or what is known as an “intermittent” sweep, in which the windscreen wipers 2 remain in the rest position for a predetermined duration between each sweep cycle.

It is also possible to stop the rotation of the motor 10 as soon as the processing unit 5 detects a rising edge expected by the processing unit 5 as that of the peak corresponding to the predetermined angular position of a rest position. By providing detection on the rising edge, it may be unnecessary to measure the angle at the centre of the circle C of the switched angular reference point 20a, 20b′ before it is possible to determine whether it corresponds to one or the other of the end positions.

The same device for identifying a rest position 4 may be used for the second drive device 3 of the wiping system 1.

Thus, FIG. 6 shows the detection signal S2 obtained over a sweep cycle for a second device for identifying a rest position 4 of the wiping system 1, for example that of the windscreen wiper 2 for wiping the glazed surface 6 of the right rear door 7b (seen from the rear of the vehicle).

The device for detecting a rest position 4 also rotates in the clockwise direction, the inversion of the rotation of the windscreen wipers 2 being provided by a rest position of the motor 10 diametrically opposed to that of the motor 10 of the left rear door 7a.

The processing unit 5 is configured to set a rest position of the motor 10 when the reference point follower 21 reaches a position symmetrical to a rest position of the first device for identifying a rest position 4, that is to say the second angular reference point 20b in the example. The rest positions of the device for detecting a rest position 4 of the right and left doors are thus symmetrically inverted.

The travel along the second semicircle C2 therefore corresponds to the upstroke of the sweep cycle. The reference point follower 21 of the device for detecting a rest position 4 thus travels along the second semicircle C2 when the reference point follower 21 of the device for detecting a rest position travels along the first semicircle C1. The detection signal S2 received by the processing unit 5 thus has a first portion similar to the second portion P2.

Then, when the reference point follower 21 sweeps the first semicircle C1, corresponding in this case to the downstroke of the sweep cycle, the detection signal S2 has a second portion P2 similar to the first portion P1.

As in the case of the right-hand device for detecting a rest position 4, the detection signal S2 is asymmetrical. It has different portions P1, P2 in the upstroke and downstroke. The processing unit 5 can thus determine, when the user requests that the wiping be stopped (case A or B), whether the windscreen wiper 2 is in the upstroke or the downstroke, by counting the number of third peaks ARF3.

The processing unit 5 can then determine whether it must command the motor 10 to stop on the detection of the rising edge of the next peak ARF1 which it expects to correspond to the next second angular reference point (case B in FIG. 6), since it has determined that the sweep is in the downstroke (portion P1), or whether it must wait for the passage of two successive angular reference points 20a, 20b before the motor 10 reaches the angular position determined for the fixed stop (case A in FIG. 6), since it has determined that the sweep is in the upstroke (portion P2).

Thus the same device for detecting a rest position 4 may be used for the right and left doors, since a rest position may be determined in the processing unit 5 as corresponding to the first or the second angular reference point 20a, 20b, by counting the intermediate reference points 20c. This avoids the use of different sets of equipment which are required in the prior art for the manufacture of geared motor units whose reference points must be positioned in symmetrical rest positions, and also avoids the use of different sets of equipment for moulding distinct types of enclosures. The manufacturing and assembly costs are therefore reduced. Furthermore, the management of procurement is facilitated, since the right and left drive devices 3 are identical.

According to a second exemplary embodiment shown in FIG. 7, the angle α2 of the intermediate angular reference point 20c at the centre of the circle C is different from the angles α1 at the centre of the circle C of the first and second angular reference points 20a, 20b. For example, it is smaller (FIG. 7). An intermediate angular reference point having an angle at the centre of the circle C which is notably different from those of the first and second angular reference points 20a, 20b enables the processing unit 5 to ensure that the detected peak is to be associated with an intermediate angular reference point 20c, and not an angular reference point 20a, 20b associated with one of the end positions of the windscreen wipers 2.

According to a third exemplary embodiment shown in FIG. 8, the device for identifying a rest position 4 has no intermediate angular reference point, but simply a first and a second angular reference point 20a, 20b′ having different angles α1, α3 at the centre of the circle C. Thus the same device for detecting a rest position 4 may be used for the right and left doors, since a rest position may be determined in the processing unit 5 as corresponding to the first or the second angular reference point 20a, 20b⁵, which are differentiated.

There may be other feasible embodiments for detecting the first and second angular reference points 20a, 20b and/or the intermediate angular reference point 20c.

For example, the detection of angular reference points 20a, 20b, 20c may be optical. For this purpose, the device for identifying a rest position 4 comprises optical means for detecting the angular reference points 20a, 20b, 20c. Provision may be made, for example, for the rotary element and the angular reference points 20a, 20b, 20c to have contrasting colours.

Thus certain means for providing detection by electrical switching may also be used. For example, the rotary element is made, as before, of plastic material, and the angular reference points 20a, 20b, 20c are formed by metal tracks.

The device for identifying a rest position 4 then also comprises a light transmitter-receiver (not shown) accommodated in an element fixed to the vehicle. The light transmitter-receiver device is configured to send and receive a light beam to and from the circle C in which the angular reference points 20a, 20b, 20c are inscribed. The metal angular reference points 20a, 20b, 20c then reflect the light more strongly than the rotary element, and may be detected.

According to another exemplary embodiment, the detection of the angular reference points 20a, 20b, 20c is magnetic. For this purpose, the device for identifying a rest position 4 comprises magnetic means, such as a Hall effect sensor, for detecting the angular reference points 20a, 20b, 20c.

Some means for providing detection by electrical switching may also be used for this purpose. For example, the rotary element is made, as before, of plastic material, and the angular reference points 20a, 20b, 20c are formed by metal tracks. According to another exemplary embodiment, the angular reference points 20a, 20b, 20c comprise magnetic tracks formed by small magnets.

The device for identifying a rest position 4 also comprises a magnetic field transmitter-receiver (not shown) accommodated in an element fixed to the vehicle. The metal angular reference points 20a, 20b, 20c then modify the magnetic field lines and may be detected.

1. A drive device comprising:
an electric motor for driving a windscreen wiper of a motor vehicle in a reciprocating movement; and
a device for identifying a rest position of said motor, said rest position being a position in which the rotation of said motor is stopped in order to stop a reciprocating cycle of the windscreen wiper at the start or end of the upstroke or at the start or end of the downstroke of the windscreen wiper,
wherein said device for identifying a rest position comprises a first and a second angular reference point, said motor is configured for driving said first and second angular reference points in rotation, the first and second angular reference points being arranged on a circle and diametrically opposed, and
wherein said drive device is configured so that one of the first and second angular reference points is chosen to correspond to the rest position of said motor.

2. The drive device as claimed in claim 1, further comprising at least one intermediate angular reference point arranged on the circle in which the first and second reference points are inscribed, and which is spaced apart from the first and second angular reference points.

3. The drive device as claimed in claim 2, characterized in that a number of intermediate angular reference points arranged on a semicircle between the first and the second angular reference points is greater than a number of intermediate angular reference points arranged on the other semicircle.

4. The drive device as claimed in claim 3, further comprising a single intermediate angular reference point.

5. The drive device as claimed in claim 1, wherein the angular reference points define identical angles at the centre of the circle.

6. The drive device as claimed in claim 2, wherein the intermediate angular reference point defines an angle at the centre of the circle which is different from the angles at the centre of the circle of the first and second angular reference points.

7. The drive device as claimed in claim 1, wherein the first and the second angular reference points define different angles at the centre of the circle.

8. The drive device as claimed in claim 1, wherein the angular reference points are made of metal.

9. The drive device as claimed in claim 1, further comprising a reference point follower, elastically biased against the circle in which the angular reference points are inscribed.

10. The drive device as claimed in claim 1, further comprising:
a continuous annular track, coaxial with said circle in which the angular reference points are inscribed, and connected to the angular reference points, and
a track follower, elastically biased against the continuous annular track.

11. The drive device as claimed in claim 10, wherein the continuous annular track and the track follower are made of metal.

12. The drive device as claimed in claim 1, wherein all the angular reference points are carried by a rotary element which is driven in rotation by the electric motor of the windscreen wiper, the angular reference points being inscribed on a circle coaxial with the rotary element.

13. The drive device as claimed in claim 12, wherein the rotary element is a gear wheel driven in rotation by the electric motor of the windscreen wiper.

14. The drive device as claimed in claim 12, wherein the rotary element is made of plastic material.

15. The drive device as claimed in claim 1, further comprising one of electrical or optical or magnetic means for detecting the angular reference points.
